(19) United States
(12) Patent Application Publication
(10) Pub. No.: US 2026/0288422 A1
(43) Pub. Date: Sep. 24, 2026

(54) GENERATING LOGGING CODE IN PROGRAM FILES

(71) Applicant: INTERNATIONAL BUSINESS MACHINES CORPORATION, ARMONK, NY (US)

(72) Inventors: LAURENTIU GABRIEL GHERGU, BUCHAREST (RO); NIKICA FULIR, VARAZDIN (HR); EDUARD-CONSTANTIN IBINCEANU, TARGOVISTE (RO); VIRGINIA GEORGESCUL, BUCHAREST (RO)

(21) Appl. No.: 19/085,117

(22) Filed: Mar. 20, 2025

(51) Int. Cl. G06F 8/30; G06F 8/71; G06F 11/34; G06F 11/362

(52) U.S. Cl. CPC G06F 8/30; G06F 8/71; G06F 11/3476; G06F 11/3636; G06F 11/3644

(57) ABSTRACT

Generating logging code in program files includes: retrieving, from a version control system, a program code file, analyzing the program code file for functions, statements, and decision points included within code of the program code file, generating, based on the analyzing, one or more log statements, and adding, based on the analyzing, the one or more log statements into the program code file, thereby revising the program code file for deployment.

### BACKGROUND

### Field of the Disclosure

The field of the disclosure is data processing, or, more specifically, methods, systems, and products for generating logging code in program files.

### Description of Related Art

Typically, in the software development process, programmers are responsible for incorporating log information or statements into their program code to facilitate post-deployment analysis and error resolution. However, this task is often neglected or inadequately addressed, leading to significant challenges in identifying and resolving issues in production environments. Oftentimes, developers may fail to include sufficient logging code in the program code file, resulting in incomplete or inaccurate log data, which in turn can lead to prolonged debugging cycles, increased costs, and decreased application reliability. In such scenarios, developers are forced to rely on manual analysis of in-memory variables and step-by-step execution tracing, which can be time-consuming and error-prone.

### SUMMARY

Methods, apparatus, and systems for generating logging code in program files according to various embodiments are disclosed in this specification. In accordance with one aspect of the present disclosure, a method of generating logging code in program files includes retrieving, from a version control system, a program code file, analyzing the program code file for functions, statements, and decision points included within code of the program code file, generating, based on the analyzing, one or more log statements, and adding, based on the analyzing, the one or more log statements into the program code file, thereby revising the program code file for deployment.

In accordance with another aspect of the present disclosure, a system for generating logging code in program files may include a processor, memory operatively coupled to the processor, and a log injector module included within the memory and configured to: retrieve, from a version control system, a program code file, analyze the program code file for functions, statements, and decision points included within code of the program code file, generate, based on the analyzing, one or more log statements, and add, based on the analyzing, the one or more log statements into the program code file, thereby revising the program code file for deployment.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 is a block diagram of an example computing architecture configured for generating logging code in program files in accordance with embodiments of the present disclosure.

FIG. 2 is a block diagram of an example computing environment configured for generating logging code in program files according to some embodiments of the present disclosure.

FIG. 3 is a flowchart of an example method for generating logging code in program files according to some embodiments of the present disclosure.

FIG. 4 is a flowchart of another example method for generating logging code in program files according to some embodiments of the present disclosure.

### DETAILED DESCRIPTION

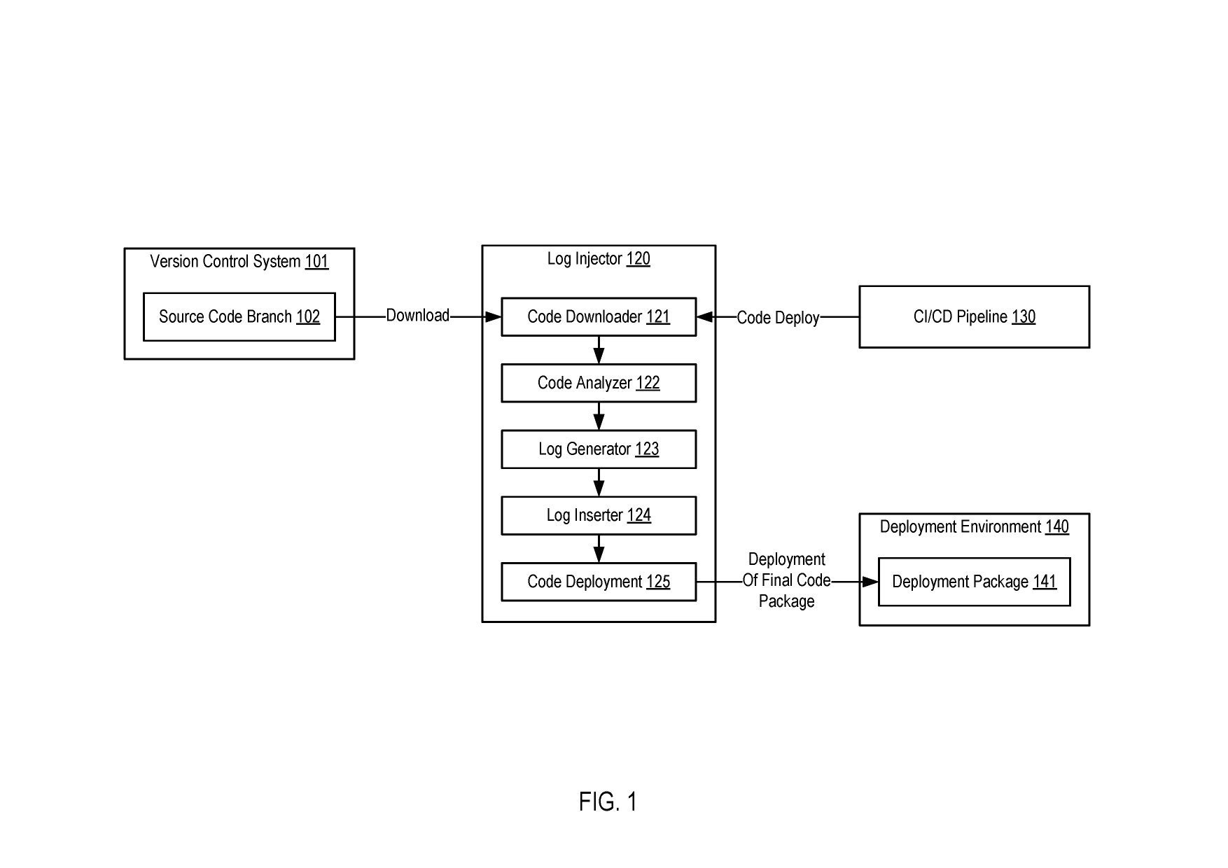

In existing embodiments, various log libraries and frameworks exist to facilitate logging in software development (e.g., Log4j, Logback, and Serilog). However, these embodiments do not address the specific problem of insufficient logging coverage in program code, and these tools primarily provide a means for developers to write log instructions into their code but fail to offer comprehensive code coverage analysis or automated logging capabilities. Further, existing embodiments often require manual configuration and maintenance, which can be cumbersome and prone to errors, and they may not integrate seamlessly with other development tools and workflows, leading to additional complexity and overhead. The remaining disclosure describes an automated logging tool designed to seamlessly integrate with software development pipelines, revolutionizing the way developers approach logging and debugging. For example, by leveraging a sophisticated algorithm, the embodiments of the present disclosure will inject log statements into program code files, thereby eliminating the need for manual logging and reducing clutter in code views. The overall architecture of the embodiments of the present disclosure is presented in FIG. 1 below.

Exemplary methods, systems, and products for generating logging code in program files in accordance with the present disclosure are described with reference to the accompanying drawings, beginning with FIG. 1. FIG. 1 sets forth a block diagram of an example architecture configured for generating logging code in program files in accordance with embodiments of the present disclosure. The example of FIG. 1 includes version control system 101, which includes source code branch 102. The example of FIG. 1 also includes log injector 120, which includes code downloader 121, code analyzer 122, log generator 123, log inserter 124, and code deployment 125. The example of FIG. 1 also includes CI/CD pipeline 130 and deployment environment 140.

The example version control system 101 of FIG. 1 is configured to store multiple developed program code files, such as applications, firmware, system files or programs, or the like. For example, once a program code file has been developed, or updated, by a developer, the file is stored in the version control system 101 (e.g. at source code branch 102).

The example code downloader 121 of FIG. 1 is included within log injector 120 and is configured to retrieve a program code file from the version control system 101 responsive to a request to deploy the program code file (e.g. by a deployment environment, such as deployment environment 140). In such an embodiment, a computing system requesting to deploy a particular application or other program file may trigger the log injector to retrieve the associated program code file from the version control system in order to add in the log statements into the code. In some embodiments, the version control system may be GitHub, GitLab, Mercurial, or the like.

In some embodiments, the code downloader 121 is configured to interact with, or be seamlessly integrated with, a developer’s CI/CD (Continuous Integration/Continuous Deployment) pipeline 130, where the program code file is retrieved directly from the developer rather than through an intermediate version control system. Such embodiments allow developers to run the logging process automatically as part of their development workflow, so that developers do not need to worry about maintaining log information or cluttering their code views with unnecessary logs.

The example code analyzer 122 of FIG. 1 is included within log injector 120 and is configured to analyze each line of code included within the program code file and then identify each function, statement, and decision point included within the code. In such an embodiment, a computing system requesting to deploy a particular application or other program file may trigger the log injector to retrieve the associated program code file from the version control system in order to automatically add in the log statements into the code.

The example log generator 123 of FIG. 1 is included within log injector 120 and is configured to create, for each function, statement, and decision point identified during the analysis of the code, a log statement using a predefined format. In such an embodiment, the log injector may ensure that the log information is included within the code that for the entirety of the code, thereby avoiding any issues from inadequate log coverage. The log statements generated may be generated to include different data, depending on what part of the code the log statement is generated for. For example, for each function in the code, the log generator may generate a log line (for injection at the start of the function) to indicate its execution. The log generator may also, for each function in the code, generate a log line (for injection at the end of the function) to report performance metrics. For each statement included in the code, the log generator may generate (for injection at the top of each statement) a log statement that provides detailed information about the execution flow at, and proximate to, the statement. For each decision point statement identified in the code, the log generator may generate a log statement indication which branch of the decision what executed.

In some embodiments, the log generator is configured to take into account the optimal log line format based on one or more factors, such as what data to log, how much data to log, and when to log the data. Such embodiments ensure that the generated log statements are relevant, concise, and easy to analyze. In one embodiment, the log generator may consider correlation ID generation, where the log statement may include a unique correlation ID for each user of the program file, where the log statements are generated for each execution flow, thereby enabling developers to track asynchronous code execution (i.e. execution across asynchronous requests). In another embodiment, the log generator may consider thread ID integration, where each log statement or log line generated may include the current thread ID (the ID of the thread being executed at the time the log statement is propagated during execution). Such an embodiment allows for easy filtering and analysis using tools (e.g. Grafana, etc.) and also allows for tracking multithreading code. In another embodiment, the log generator may consider toggle-based logging, where an administrator-configurable toggle is included in the log injector. In such an embodiment, the toggle may enable or disable the logging of (and the inclusion within log statements of) memory usage and CPU utilization levels. Such an embodiment provides developers with fine-grained control over log data. In another embodiment, the log generator may consider execution time information, where each log line may include the execution time information, thereby highlighting the time spent between code statements. Any of the above embodiments may be a configurable option for the log injector and may be based on the decision of an administrator.

The example log inserter 124 of FIG. 1 is included within log injector 120 and is configured to inject the generated log statements into the code of the program code file based on the analysis performed by the code analyzer 122. As explained above, this includes adding log statements at the start of each function, at the end of each function, at the top of each statement, and at each decision point.

The example log injector 120 is configured to be implemented using various programming languages and frameworks, depending on the development environment. The example code deployment 125 of FIG. 1 is included within log injector 120 and is configured to send the updated / edited program code file (now including the inserted log statements) in a deployment package (such as deployment package 141) to the deployment environment (such as deployment environment 140) where deployment of the program code file was originally requested. The code deployment 125 portion of the log injector 120 thereby ensures seamless integration with existing development workflows, allowing developers to focus on writing code while the log injector 120 handles logging tasks once the developed code is available for deployment. In embodiments where the log injector is integrated with CI/CD pipeline 130, the code deployment 125 is configured to send the updated program code file back to the CI/CD pipeline (not shown in FIG. 1), such as at a “build and display” step of the pipeline.

In some embodiments, the log injector may use an AI (artificial intelligence) model to describe the semantic purpose of a code statement, and a text description can be added to the log statement for enhanced debugging capabilities. Such an embodiment may be a configurable option for the log injector and may be based on the decision of an administrator.

In some embodiments, the log injector may use an AI (artificial intelligence) model to describe the semantic purpose of a code statement, and a text description can be added to the log statement for enhanced debugging capabilities. Such an embodiment may be a configurable option for the log injector and may be based on the decision of an administrator.

In some embodiments, the log injector may carry out selective logging, where log statements are added only in specific locations of the code that have higher significance when it comes to potential issues appearing. Such an embodiment requires identifying one or more sections of code that satisfy a “significance threshold”, when may be determined by taking into account the complexity of the code, the relative importance of the code, the frequency of the section of code being executed, and the like. Such a determination of the one or more sections of code may be performed by a model (such as an AI model include within, or coupled to, the log injector). Such an embodiment may be a configurable option for the log injector and may be based on the decision of an administrator. For example, upon analyzing the code by code analyzer 122, the log injector is configured to (provided such selective logging option is switched on for the log injector, generate and insert log statements only for the identified sections of code.

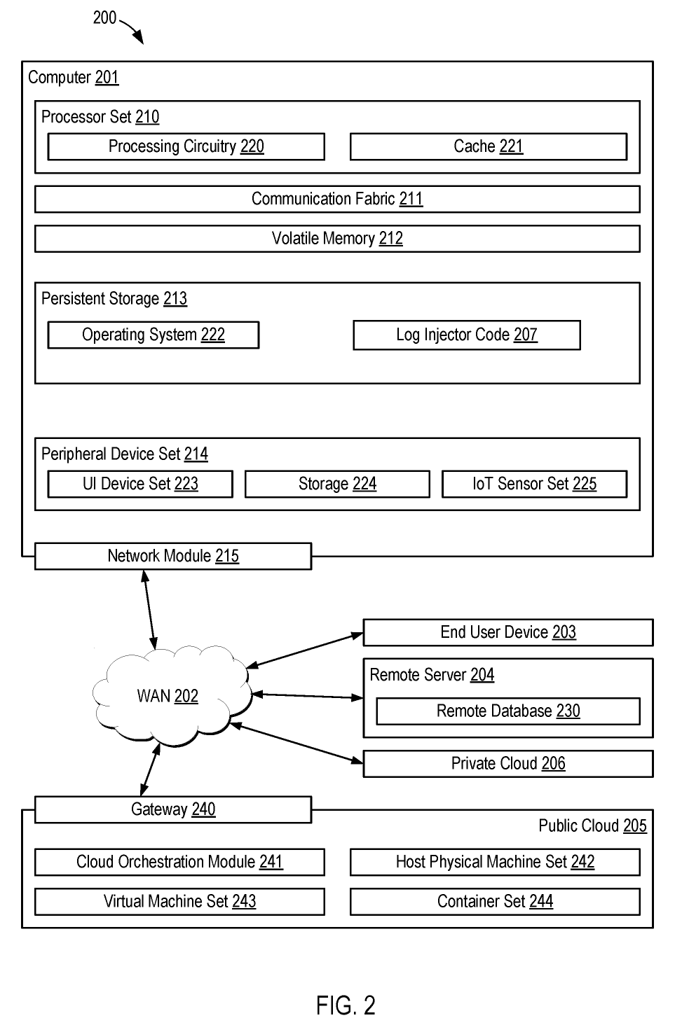

For further explanation, FIG. 2 sets forth a block diagram of computing environment 200 configured for dynamically reducing FFDC resource consumption in accordance with embodiments of the present disclosure. Computing environment 200 contains an example of an environment for the execution of at least some of the computer code involved in performing the inventive methods, such as log injector code 207 or operating system 222. In addition to log injector code 207, computing environment 200 includes, for example, computer 201, wide area network (WAN) 202, end user device (EUD) 203, remote server 204, public cloud 205, and private cloud 206. In this example embodiment, computer 201 may include the computing architecture shown in FIG. 1, and includes processor set 210 (including processing circuitry 220 and cache 221), communication fabric 211, volatile memory 212, persistent storage 213 (including operating system 222 and log injector code 207, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244. In one embodiment, the log injector code 207 is included in the log injector 120 of FIG. 1 and is configured to retrieve a program code file from version control history, analyze the program code file, generate log statements, and add the log statements into the program code file. In another embodiment, the log injector code 207 is included within the operating system 222.

Computer 201 may take the form of a desktop computer, laptop computer, tablet computer, smart phone, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in log injector code 207 in persistent storage 213.

Communication fabric 211 is the signal conduction path that allows the various components of computer 201 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in log injector code 207 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215. Network module 215 may be configured to communicate with other systems or devices, such as sensors 225, for receiving sensor measurements.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

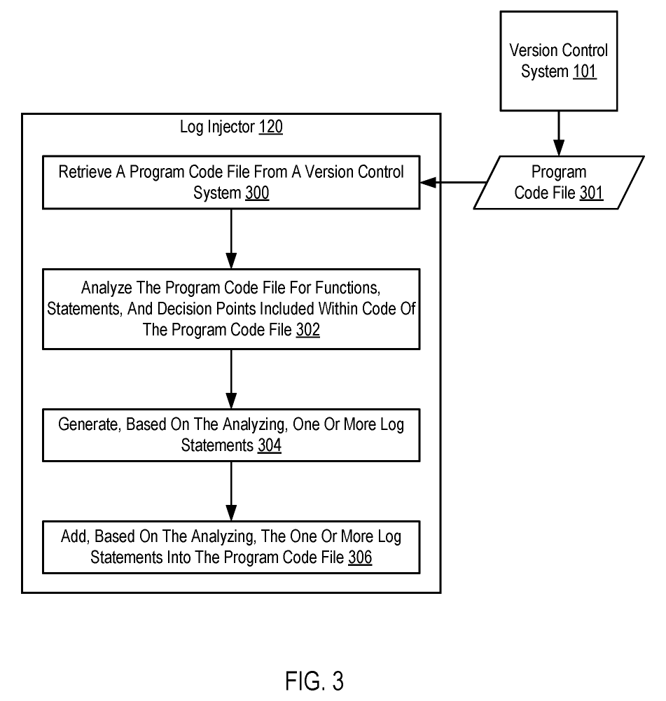

For further explanation, FIG. 3 sets forth a flow chart illustrating an exemplary method of generating logging code in program files according to embodiments of the present disclosure. The method of FIG. 3 includes retrieving 300 a program code file from a version control system. Retrieving 300 a program code file may be carried out by log injector 120 downloading the program code file 301 from version control system 101. In some embodiments, retrieving the program code file from the version control system is performed responsive to (i.e. triggered by) a request to deploy the program code file. In some embodiments, the request to deploy the file may be made by an application, firmware, the operating system, or the like. For example, upon an operating environment requesting to execute an application, the program code file for that application has been requested to be deployed, triggering the log injector to retrieve the program code file of the application from a version control system.

The method of FIG. 3 also includes analyzing 302 the program code file for functions, statements, and decision points included within code of the program code file. Analyzing 302 the program code file may be carried out by log injector 120 by parsing each line of code within the program code file and identifying instances of functions, statements, and decision points (such as if-else statements). Continuing with the above example, the log injector is configured to, upon being triggered, analyze each line of the code included within the program code file of the application.

The method of FIG. 3 also includes generating 304, based on the analyzing, one or more log statements. Generating 304 one or more log statements may be carried out by log injector 120 by creating, for each function, statements, and decision point identified during the analysis of the code, a log statement using a predefined format. In some embodiments, the predefined format may be customized depending on the embodiment, such as being based on whether the log statement is for a function, a statement, or a decision point, end the like. In some embodiments, the format may include one or more of: a message generated by an AI (artificial intelligence) model describing the current activity or next activity, a list of variables in memory with associated values (for debugging purposes), a correlation ID for tracking code execution across asynchronous requests, and a log level (e.g., DEBUG) to control logging verbosity.

The method of FIG. 3 also includes adding 306, based on the analyzing, the one or more log statements into the program code file. Adding 306 the one or more log statements into the program code file may be carried out by log injector 120 by injecting (i.e. inserting) each of the generated log statements within the program cod file at their corresponding locations. Continuing with the above example, the log injector is configured to, upon generating one or more log statements corresponding to each identified function, statement, and decision point identified within the application file code, insert the generated log statements into the program code file at their respective locations in the code. By analyzing the program code file, generating, and adding log statements into the program code file, the log injector is configured to update or revise the program code file (upon a request to deploy the file) to include the necessary log statements useful for debugging or other services, thereby revising the program code file for deployment.

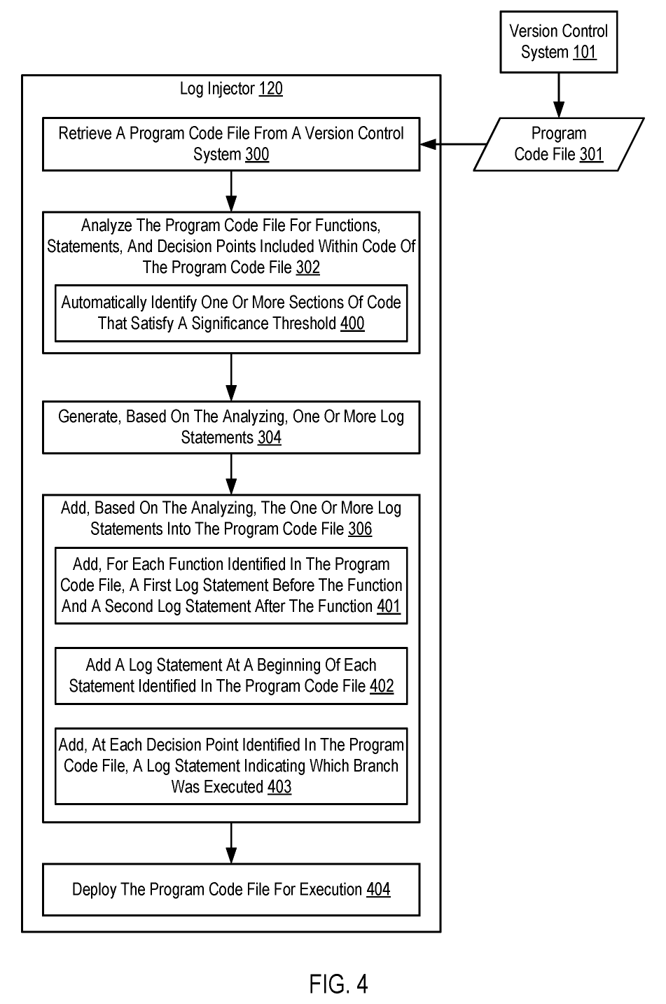

For further explanation, FIG. 4 sets forth a flow chart illustrating another exemplary method of generating logging code in program files according to embodiments of the present disclosure. The method of FIG. 4 differs from the method of FIG. 3 in that the method of FIG. 4 further includes, as part of analyzing 302 the program code file for functions, statements, and decision points included within code of the program code file, identifying 400 one or more sections of code that satisfy a significance threshold. Identifying 400 one or more sections of code that satisfy a significance threshold may be carried out by log injector 120 by determining a complexity of each portion of the code and determining which portions of the code have a higher significance (such as above a significance threshold), where more significant or complex portions of the code have a higher likelihood of causing potential issues or errors. For example, the edge cases of code often produce the most amount of bugs, and thus these edge cases may be identified and selected as being the only portions of the program code file for which analysis and automatic log generation and inserting. By performing the method of FIG. 3 for only certain sections of code that meet a significance threshold, the log injector is configured to streamline the log generation method by inserting logs only into portions of the code which would benefit the most from them. In one embodiment, identifying the one or more sections of the code may include performing cyclomatic complexity analysis on the program code file to identify complex sections of the code, so that log statements may generated and added only to those sections accordingly. This is based on the idea that the more complex the code is, the more probability of bugs being present, and so logs will be required, i.e. the log statements will be propagated with relevant data during the execution of that file for the portions of code that have had log statements inserted into them.

The method of FIG. 4 also includes, as part of adding 306, based on the analyzing, the one or more log statements into the program code file, adding 401, for each function identified in the program code file, a first log statement before the function and a second log statement after the function. Adding 401, for each function identified in the program code file, a first log statement before the function and a second log statement after the function may be carried out by log injector 120 by adding a generated (during generating 304) first log statement at the beginning of each function, where the log statement includes a function name indicating that the function has been executed, and also adding a second log statement at the end of the function, where the log statement includes the function name and also includes the execution time. In such an embodiment, the log injector is configured to add log statements into the program code file at each function for future use in potential debugging or analysis once the file is executed.

The method of FIG. 4 also includes, as part of the adding 306, adding 402 a log statement at a beginning of each statement identified in the program code file. Adding 402 a log statement at a beginning of each statement identified in the program code file may be carried out by log injector 120 by adding a generated (during generating 304) log statement at the beginning of each statement within the code, where the log statement may include one or more descriptors of the statement, values associated with the statement, and the like. In such an embodiment, the log injector is configured to add log statements into the program code file at each statement for future use in potential debugging or analysis once the file is executed, providing understanding and context for a given portion of code.

The method of FIG. 4 also includes, as part of the adding 306, adding 403, at each decision point identified in the program code file, a log statement indicating which branch was executed. Adding 403, at each decision point identified in the program code file, a log statement indicating which branch was executed may be carried out by log injector 120 by adding a generated (during generating 304) log statement at the end of each statement identified as a decision point, where the log statement includes an indication of which branch was executed for the decision point. In such an embodiment, the log injector is configured to add log statements into the program code file at each decision point for future use in potential debugging or analysis once the file is executed, providing understanding for which decision was made at the given decision point during execution of the program code file after deployment.

The method of FIG. 4 also includes deploying 404 the program code file for execution. Deploying 404 the program code file for execution may be carried out by the log injector by sending the updated / edited program code file (in a deployment package) to the deployment environment where deployment of the program code file was originally requested. In such embodiments, the log injector is configured to automatically edit / revise program code files as they are being requested for deployment, thereby providing useful log statements within the code to be referenced in the future upon any debugging or servicing. Such embodiments also increases efficiency of program code developers because they no longer need to manually enter in all of the log statements into the code as it is being written or updated, thereby increasing overall development efficiency. Further, even if program code files are updated within the version control system, adding the log statements each time the program code file is deployed ensures even updated files include sufficient and proper logging statements.

In view of the explanations set forth above, readers will recognize that the benefits of generating logging code in program files according to embodiments of the present disclosure include:

Increasing log coverage performance by ensuring recently updated program code files include updated log statements upon deployment, since each file has the statements added to them each time it is deployed.

Increasing program code development efficiency by removing the need for developers to include detailed log statements or code within the program code files.

Faster time to resolution for production issues as developers will have a very clear trace of the code that produced the issue in production.

Easier to read code (lack of log information), which may help developers to produce quality code faster.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of generating logging code in program files, the method comprising:
retrieving, from a version control system, a program code file;
analyzing the program code file for functions, statements, and decision points included within code of the program code file;
generating, based on the analyzing, one or more log statements; and
adding, based on the analyzing, the one or more log statements into the program code file, thereby revising the program code file for deployment.

2. The method of claim 1, wherein adding the one or more log statements into the program code file includes adding, for each function identified in the program code file, a first log statement before the function and a second log statement after the function.

3. The method of claim 1, wherein adding the one or more log statements into the program code file includes adding a log statement at a beginning of each statement identified in the program code file.

4. The method of claim 1, wherein adding the one or more log statements into the program code file includes adding, at each decision point identified in the program code file, a log statement indicating which branch was executed.

5. The method of claim 1, wherein the one or more log statements are added only to one or more sections of code that satisfy a significance threshold.

6. The method of claim 5, wherein the one or more sections of code are identified during the analyzing of the program code file.

7. The method of claim 1, wherein a log statement of the one or more log statements includes a thread ID identifying a current thread being executed.

8. The method of claim 1, wherein a log statement of the one or more log statements includes a unique correlation ID for a corresponding execution flow for tracking asynchronous code execution.

9. The method of claim 1, wherein a log statement of the one or more log statements includes values identifying memory usage and CPU utilization levels.

10. The method of claim 1, wherein a log statement of the one or more log statements includes execution timing information indicating time spent between code statements.

11. The method of claim 1, further comprising deploying the program code file for execution.

12. The method of claim 1, wherein retrieving, from the version control system, the program code file is performed responsive to a request to deploy the program code file.

13. A system for generating logging code in program files, the system comprising:
a processor;
memory operatively coupled to the processor; and
a log injector module included within the memory and configured to:
retrieve, from a version control system, a program code file;
analyze the program code file for functions, statements, and decision points included within code of the program code file;
generate, based on the analyzing, one or more log statements; and
add, based on the analyzing, the one or more log statements into the program code file, thereby revising the program code file for deployment.

14. The system of claim 13, wherein adding the one or more log statements into the program code file includes adding, for each function identified in the program code file, a first log statement before the function and a second log statement after the function.

15. The system of claim 13, wherein adding the one or more log statements into the program code file includes adding a log statement at a beginning of each statement identified in the program code file.

16. The system of claim 13, wherein adding the one or more log statements into the program code file includes adding, at each decision point identified in the program code file, a log statement indicating which branch was executed.

17. A computer program product comprising a computer readable storage medium and computer program instructions stored therein that, when executed, are configured to:
retrieve, from a version control system, a program code file;
analyze the program code file for functions, statements, and decision points included within code of the program code file;
generate, based on the analyzing, one or more log statements; and
add, based on the analyzing, the one or more log statements into the program code file, thereby revising the program code file for deployment.

18. The computer program product of claim 17, wherein adding the one or more log statements into the program code file includes adding, for each function identified in the program code file, a first log statement before the function and a second log statement after the function.

19. The computer program product of claim 17, wherein adding the one or more log statements into the program code file includes adding a log statement at a beginning of each statement identified in the program code file.

20. The computer program product of claim 17, wherein adding the one or more log statements into the program code file includes adding, at each decision point identified in the program code file, a log statement indicating which branch was executed.
